(19) United States
(12) Patent Application Publication
(10) Pub. No.: US 2008/0296117 A1
(43) Pub. Date: Dec. 4, 2008

(54) Electrically Actuated Clutch Torque Signature

(76) Inventors: Brian E. Leising, Central, SC (US); Robert Scott Biggers, Walhalla, SC (US)

Correspondence Address: BorgWarner/BHGL, 524 South Main Street, Suite 200, Ann Arbor, MI, 48104, US

(21) Appl. No.: 12/117,250

(22) Filed: May 8, 2008

Related U.S. Application Data
(60) Provisional application No. 60/940,569, filed on May 29, 2007.

(51) Int. Cl. F16D 27/10; G01M 13/02

(52) U.S. Cl. 192/84.6; 73/115.02

(57) ABSTRACT

An electrically actuated torque transfer device for use in a motor vehicle including an input shaft coupled to one or more output shafts. A modulating clutch assembly selectively couples the input shaft to the output shaft and includes an electrical clutch operator. The clutch assembly transfers torque from the input shaft to the at least one output shaft in proportion to an electrical current applied to the electrical clutch operator. A machine readable calibration tag is attached to the torque transfer device to store a unique torque profile for each torque transfer device. The torque profile includes a range of measured torque values transferred from the input shaft to the output shaft for each of a range of applied electrical currents.

### CROSS REFERENCE TO RELATED APPLICATION

This application claims the benefit of U.S. provisional application No. 60/940,569 filed on May 29, 2007, the entirety of which is hereby incorporated by reference.

### BACKGROUND OF THE INVENTION

1. Field of the Invention

The present invention generally relates to torque transfer devices. More specifically, the invention relates to electrically actuated clutches for mechanical power transmission systems especially useful in motor vehicle powertrains.

2. Description of Related Art

One type of torque transfer devices of the electrically actuated clutch type, proportionally transfer torque from an input shaft to an output shaft based on the amount of current applied to an electrical actuator (applied as a constant current level based on applied voltage, or at an average level through pulse width modulation of applied voltage or some other modulation scheme). Each design requires the application of a certain amount of current to the electrical actuator to cause the clutch to transfer a given value of torque. Due to manufacturing and component variations between units of a given design, the actual current required to produce a certain torque transfer will vary. In other words, for a given current, the amount of torque each unit will transfer is often different.

A powertrain control unit (PCU) may be configured to apply current to engage the electrical actuator when desired. One example transfers torque from a front wheel drive transaxle to a rear axle of a motor vehicle. Since the amount of current required to transfer each of a range of desired torques will vary, existing PCU's are programmed to use average values. This results in inconsistencies between vehicles when engaging the torque transfer device. As result, too much or too little torque may be transferred, which can lead to hard or soft engagement of, for example, the rear axle.

In view of the above, there exists a need to provide more consistent engagement of electrically actuated torque transfer devices in motor vehicle application.

### SUMMARY OF THE INVENTION

In satisfying the above need, as well as overcoming the enumerated drawbacks and other limitations of the related art, the present invention provides an electrically actuated torque transfer device for use in a motor vehicle. The torque transfer device includes an input shaft and at least one output shaft coupled to the input shaft. One or more modulating clutch assemblies couple the input shaft to one or more output shafts. The modulating clutch assembly includes an electrical clutch operator configured to selectively transfer torque from the input shaft to the at least one output shaft in proportion to an electrical current applied to the electrical clutch operator. A machine readable calibration designator is attached to the torque transfer device. The calibration designator includes a unique torque profile of the device having a range of torque values transferred from the input shaft to the output shaft for a range of electrical currents applied to the electrical clutch operator.

In some embodiments, the machine readable calibration designator includes at least one of a barcode, a magnetic strip, and alphanumeric characters. The barcode may have a one dimensional barcode, a two dimensional barcode, a stacked barcode, and combinations thereof.

In the described embodiments, the modulating clutch assembly has first and second sets of interleaved clutch plates. The first set is coupled to the input shaft and the second set is coupled to the output shaft. The electrical clutch operator directly or indirectly axially compresses the interleaved clutch plates to frictionally transfer torque from the input shaft to the output shaft.

In still other embodiments, the electrical clutch operator includes at least one of an electromagnetic device, an electromechanical device, an electrohydraulic device, and combinations thereof. In one example, the electromagnetic device includes a ball ramp operator having a pair of opposed members having complimentarily configured opposed ramped recesses and rolling members disposed in the recesses whereby relative rotation of the members translates said the members axially. An electromagnetic coil may be magnetically coupled to at least one of the circular members and configured to provide relative rotation of the members to axially compress the interleaved clutch plates. In another example, the electromechanical device includes an electric motor configured to mechanically compress the interleaved clutch plates. In other examples, an electrohydraulic device is provided having n electric pump and/or an electrically actuated valve configured to hydraulically compress the interleaved clutch plates.

The present invention further encompasses a method of calibrating a powertrain control unit using the machine readable calibration designator.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a torque transfer device according to the present invention;

FIG. 2 is a calibration designator according to the present invention;

FIG. 3 is a schematic of a motor vehicle according to the present invention; and

FIG. 4 is a flow chart illustrating a method according to the present invention.

### DETAILED DESCRIPTION

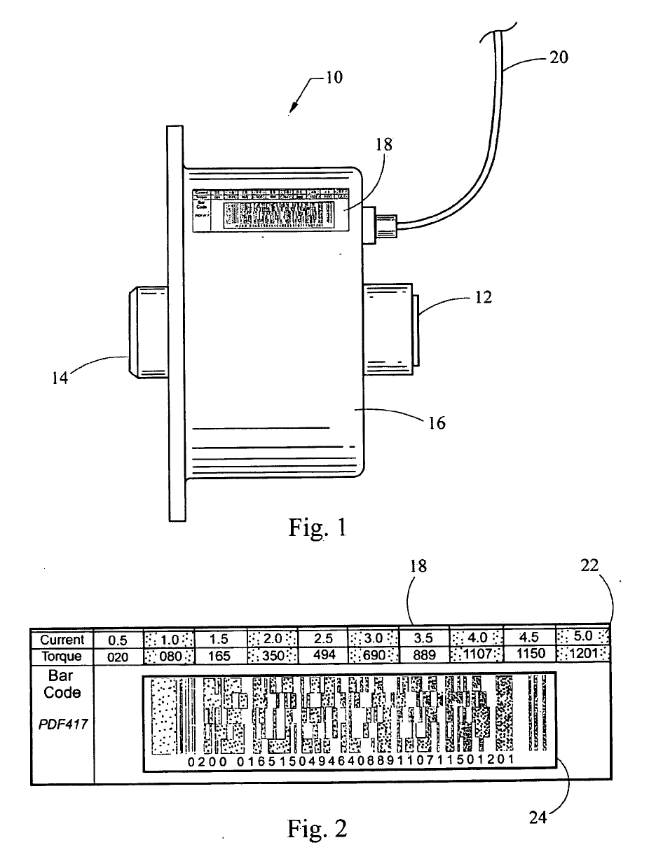

Referring now to FIG. 1, an electrically actuated torque transfer device embodying the principles of the present invention is illustrated therein and designated at 10. As its primary components, the device 10 includes an input shaft 12 selectively coupled to an output shaft 14 by a modulating clutch assembly (not shown) contained within a housing 16. A machine readable calibration designator 18 is associated with the device 10.

The modulating clutch assembly selectively transfers torque from the input shaft 12 to the output shaft 14 in proportion to an electrical current applied to an electrical clutch operator (not shown) of the modulating clutch assembly through a conductor 20. The electrical clutch operator may be any appropriate device for actuating the modulating clutch assembly to selectively couple the input shaft 12 to the output shaft 14. Some examples include, but are not limited to, electromagnetic devices, electromechanical devices, and electrohydraulic devices.

Various embodiments of the modulating clutch assembly include, but are not limited to, two sets of interleaved clutch plates (not shown). One set may be coupled to the input shaft 12 and the other coupled to the output shaft 14. The interleaved clutch plates are configured such that axial compression of the two sets of plates transfers torque between the two shafts 12 and 14 through frictional forces. The axial compression is directly or indirectly provided by an appropriate electrical clutch operator as mentioned above and described in more detail below.

One example of a torque transfer device having one or more modulating clutch assemblies including interleaved clutch plates and an electromagnetic clutch operator is disclosed in U.S. Pat. No. 6,905,008 to Kowalsky which is herein incorporated by reference. Another example is disclosed in U.S. Pat. No. 5,839,328 to Showalter which is herein incorporated by reference. These examples include a ball ramp operator having a pair of opposed circular members with complimentary, opposed and ramped recesses. Rolling members are disposed within the recesses such that relative rotation of the circular members translates them axially. An electromagnetic coil is magnetically coupled to one of the circular members such that application of an electrical current to the coil results in relative rotation of the circular members. The resulting axial translation compresses the interleaved clutch plates and frictionally couples an input shaft with one or more output shafts.

The electromechanical device may include any appropriate electric motor configured to mechanically compress the interleaved clutch plates. The electrohydraulic device may include an electric pump and/or an electrically actuated valve to hydraulically compress the interleaved clutch plates.

It should be appreciated that the above devices are merely non-limiting examples. Other embodiments may include any other appropriate means of selectively coupling the input shaft 12 to the output shaft 14 through the application of an electrical current.

Due to normal manufacturing variations between each unit of the torque transfer devices 10 produced, the amount of torque that may be transferred from the input shaft 12 to the output shaft 14 for a given current applied to the electrical clutch operator will vary. It is desirable to measure the amount of variation for each unit, for instance, on an end of line production test stand to determine a unique torque profile having the actual torque transferred for each of a range of applied electrical currents. This information is encoded into the machine readable calibration tag 18.

One example of the calibration designator 18 is shown in FIG. 2. This example is a tag 60 having an optional chart 22 showing the unique torque profile of one unit of the device 10. The tag 60 is attached to the housing 16. As shown, to transfer twenty Newton-meters (N-m) of torque this example requires the application of 0.5 amps of current. To transfer three hundred and fifty (N-m) requires 2.0 amps, and so on. This information is also stored in a machine readable barcode 24. While this example shows a two dimensional barcode, any barcode may also be used including, but not limited to, one dimensional and stacked barcodes. In addition, other examples of the calibration designator 18 may include a magnetic strip and/or markings printed directly on the housing 16.

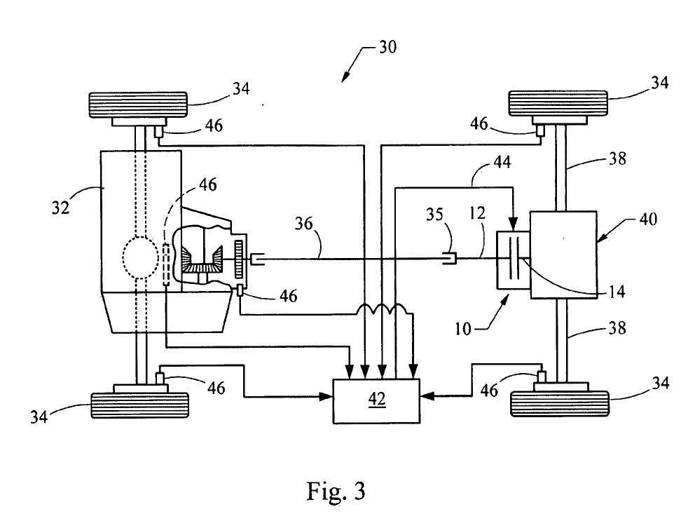

In one embodiment, the device 10 may be used in a motor vehicle 30 as shown in the schematic of FIG. 3. The motor vehicle 30 includes a motive source 32 such as an internal combustion engine or electric motor. A plurality of wheels 34 are coupled to the motive source 32 through a drive member 36 and output members 38. Two output members 38 are shown coupled to the drive member 36 using any embodiment of the torque transfer device 10. In this example, a differential 40 couples the two output members 38 to the output shaft 14 of the device 10.

A digital powertrain control unit (PCU) 42 is attached to the electrical clutch operator of the device 10 through, for example, a cable 44. During assembly of the vehicle 30, the unique torque profile for the particular unit of the device 10 being installed in the vehicle 30 encoded in the machine readable calibration designator is stored into the memory of the PCU. This forms a matched pair resulting in more consistent and improved engagement of the torque transfer device 10 by the PCU 42.

The PCU 42 is configured to provide a range of electrical current to the electrical clutch operator based on a desired amount of torque to be transferred from the drive member 36 to the output members 38. The desired amount of torque may be determined by the PCU 42 by reading a plurality of sensors 46 providing information regarding the operational state of the motor vehicle 30. It should be recognized that the level of current applied to the electrical clutch operator may be applied as a constant current level based on applied DC voltage, or at an average level through pulse width modulation of applied voltage or some other modulation scheme. This invention may further be used with any approach used in which it is useful to relate an applied signal (whether as a DC, pulsed or otherwise modulated signal applied as a current, voltage, or coded signal) to a desired value of modulated torque transfer through device 10. Moreover, a desired level of applied current (DC or pulsed in some way) may be produced through a feedback supply within PCU, in which an applied voltage is adjusted in accordance with resulting monitored current flow.

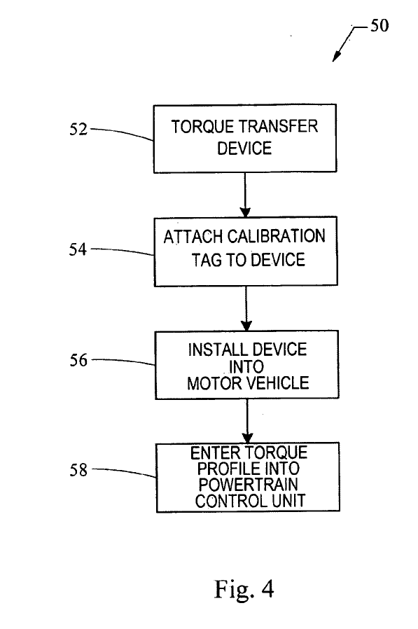

Turning now to FIG. 4, one example of a method of calibrating the PCU for use in a motor vehicle is described and designated at 50. The method includes providing a torque transfer device having a modulating clutch assembly with an electrical clutch operator characterized by a unique torque profile at box 52. Box 54 associates a machine readable calibration designator encoded with the unique torque profile with the torque transfer device and box 56 installs the torque transfer device into a motor vehicle having a powertrain control unit (PCU) configured to actuate the electrical clutch operator. At box 58, the unique torque profile encoded on the calibration designator of the device being installed into the vehicle is entered into the PCU. During assembly of the motor vehicle, for example, a barcode reader in communication with the PCU may be used to enter the torque profile into the PCU over, for instance, a k-line or CAN communications network.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. An electrically actuated torque transfer device for use in a motor vehicle, the torque transfer device comprising:
an input shaft;
at least one output shaft coupled to the input shaft;
at least one modulating clutch assembly selectively coupling the input shaft to the output shaft, the modulating clutch assembly including an electrical clutch operator and the clutch assembly being configured to transfer torque from the input shaft to the at least one output shaft in proportion to an electrical signal applied to the electrical clutch operator; and
a machine readable calibration designator associated with the torque transfer device stores a unique torque profile of the device having a range of torque values transferred from the input shaft to the output shaft for a range of the electrical signals applied to the electrical clutch operator.

2. The torque transfer device of claim 1, wherein the machine readable calibration designator includes at least one of a barcode, a magnetic strip, alphanumeric characters and combinations thereof.

3. The torque transfer device of claim 2, wherein the barcode includes at least one of a one dimensional barcode, a two dimensional barcode label, a stacked barcode, and combinations thereof.

4. The torque transfer device of claim 1, wherein the torque profile includes measured torque values for each of the range of applied electrical signals.

5. The torque transfer device of claim 1, wherein the modulating clutch assembly further includes first and second sets of interleaved clutch plates, the first set being coupled to the input shaft and the second set being coupled to the output shaft whereby the electrical clutch operator axially compresses the interleaved clutch plates to frictionally transfer torque from the input shaft to the output shaft.

6. The torque transfer device of claim 5, wherein the electrical clutch operator includes at least one of an electromagnetic device, an electromechanical device, an electrohydraulic device, and combinations thereof.

7. The torque transfer device of claim 6, wherein the electromagnetic device includes a ball ramp operator having a pair of opposed members having complimentarily configured opposed ramped recesses and rolling members disposed in the recesses whereby relative rotation of the circular members translates the circular members axially.

8. The torque transfer device of claim 7, wherein the electromagnetic device includes an electromagnetic coil magnetically coupled to at least one of the circular members and configured to provide relative rotation of the circular members to axially compress the interleaved clutch plates.

9. The torque transfer device of claim 6, wherein the electromechanical device includes an electric motor configured to mechanically compress the interleaved clutch plates.

10. The torque transfer device of claim 6, wherein the electrohydraulic device includes an electric pump configured to hydraulically compress the interleaved clutch plates.

11. The torque transfer device of claim 10, wherein the electrohydraulic device includes an electrically actuated valve configured to hydraulically compress the interleaved clutch plates.

12. The torque transfer device of claim 1, wherein the machine readable calibration designator includes at least one of a tag attached to the device, markings on a housing of the device, and combinations thereof.

13. The torque transfer device of claim 1, wherein the electrical signal is in the form of an applied current.

14. A method of calibrating a powertrain control unit for use in a motor vehicle, the method comprising:
providing at least one torque transfer device including a modulating clutch assembly having an electrical clutch operator and being characterized by a unique torque profile associated with an electrical signal applied to the electrical clutch operator;
associating a machine readable calibration designator with the torque transfer device;
installing the torque transfer device into a motor vehicle; and
entering the unique torque profile associated with the torque transfer device into a powertrain control unit electrically attached to the electrical clutch operator.

15. The method of claim 14, further comprising characterizing the unique torque profile after assembly of the torque transfer device.

16. The method of claim 15, further comprising encoding the unique torque profile in the machine readable calibration designator.

17. The method of claim 14, wherein the unique torque profile includes a range of measured torque values transferred from the input shaft to the output shaft for a range of applied electrical currents.

18. The method of claim 14, wherein the clutch assembly selectively transfers torque from an input shaft to at least one output shaft in proportion to an electrical current applied to the electrical clutch operator.

19. The method of claim 14, wherein the machine readable calibration designator includes at least one of a barcode, a magnetic strip, alphanumeric characters and combinations thereof.

20. The method of claim 19, wherein the unique torque profile is entered into the powertrain control unit using a barcode reader in communication with the powertrain control unit during assembly of the torque transfer device into a motor vehicle.

21. The torque transfer device of claim 14, wherein the machine readable calibration designator includes at least one of a tag attached to the device, markings on a housing of the device, and combinations thereof.
